(19) United States
(12) Patent Application Publication
(10) Pub. No.: US 2012/0326546 A1
(43) Pub. Date: Dec. 27, 2012

(54) Electrical Actuators with Eddy Current Reducer

(76) Inventor: Alexei Stadnik, Beverly Hills, CA (US)

(21) Appl. No.: 13/509,769

(22) PCT Filed: Nov. 10, 2010
(86) PCT No.: PCT/US2010/056100

§ 371 Date: May 14, 2012

Related U.S. Application Data
(60) Provisional application No. 61/281,174, filed on Nov. 14, 2009.

(51) Int. Cl. H01F 7/11; H02K 21/12

(52) U.S. Cl. 310/156.01; 335/229

(57) ABSTRACT

The invention provides electrical actuators with reducer of Eddy current losses (Eddy current reducer) that improves the performance of actuator. In the electrical actuators, it greatly reduces the Eddy current losses in moving conductive part from stationary permanent magnets (or in stationary conductive part from moving magnets).

### BACKGROUND OF THE INVENTION

The problem of Eddy current losses in the electrical actuators is well known. Some way for solving the problem is described in “Design and Test of an Ironless, Three Degree-of-Freedom, Magnetically Levitated Linear Actuator with Moving Magnets” by J. V. Jansen, etc.—2005 IEEE International Conference on Electric Machines and Drives. For reduction of Eddy current losses the ceramic plate is used. The plate increase the distance between stationary and moving conductive part. This way is increasing actuator envelope. When using thick and strong magnets or go to high speed (several meter per second) the thickness of ceramic plate and therefore actuator envelope increase dramatically.

### DESCRIPTION OF THE FIGURES

FIG. 1.1—Linear actuator with linear flat electric machine

FIG. 1.2—Linear actuator with linear flat electric machine and. Eddy current reducer

FIG. 2—Eddy current reducer for linear actuators with linear flat electric machine and linear tube electric machine

FIG. 3.1—Linear actuator with linear tube electric machine

FIG. 3.2—Linear actuator with linear tube electric machine and Eddy current reducer

FIG. 4.1—Rotary actuator with rotary radial (magnets inside) ironless electric machine

FIG. 4.2—Rotary actuator with rotary radial (magnets inside) ironless electric machine and Eddy current reducer

FIG. 5—Eddy current reducer for rotary actuators with rotary radial ironless electric machine (magnets inside and outside)

FIG. 6.1—Rotary actuator with rotary radial (magnets outside) ironless electric machine

FIG. 6.2—Rotary actuator with rotary radial (magnets outside) ironless electric machine and Eddy current reducer

FIG. 7.1—Rotary actuator with rotary axial ironless electric machine

FIG. 7.2—Rotary actuator with rotary axial ironless electric machine and Eddy current reducer

FIG. 8—Eddy current reducer for rotary actuators with rotary axial ironless electric machine

### DRAWINGS—REFERENCE NUMERALS

12—forcer (linear flat actuator)

14—table top (linear flat actuator)

16—magnet track (linear flat actuator)

18—magnetic plate (linear flat actuator)

20—magnets (linear flat actuator)

22—linear bearings (linear flat actuator)

24—actuator base (linear flat actuator)

26—Eddy current reducer (linear actuator)

28—pieces of ferromagnetic material or compound

30—non-magnetic spacers

32—forcer (linear tube actuator)

34—actuator base (linear tube actuator)

36—magnet track (linear tube actuator)

38—magnets (linear tube actuator)

40—tube (linear tube actuator)

42—linear bearings (linear tube actuator)

44—stator (rotary actuator, magnets inside)

46—actuator housing (rotary actuator, magnets inside)

48—rotor (rotary actuator, magnets inside)

50—magnets (rotary actuator, magnets inside)

52—table top (rotary actuator, magnets inside)

54—bearings (rotary actuator, magnets inside)

56—Eddy current reducer (rotary actuator with radial electric machine)

58—pieces of ferromagnetic material or compound

60—non-magnetic spacers

62—stator (rotary actuator, magnets outside)

64—actuator housing (rotary actuator, magnets outside)

66—rotor (rotary actuator, magnets outside)

68—magnets (rotary actuator, magnets outside)

70—table top (rotary actuator, magnets outside)

72—bearings (rotary actuator, magnets outside)

74—stator (rotary actuator, axial)

76—actuator base (rotary actuator, axial)

78—rotor (rotary actuator, axial)

82—table top (rotary actuator, axial)

84—bearings (rotary actuator, axial)

86—Eddy current reducer (rotary actuator, axial)

88—pieces of ferromagnetic material or compound

90—non-magnetic spacers

### DESCRIPTION OF THE PREFERRED EMBODIMENT

Linear Actuator with Linear Flat Electric Machine.

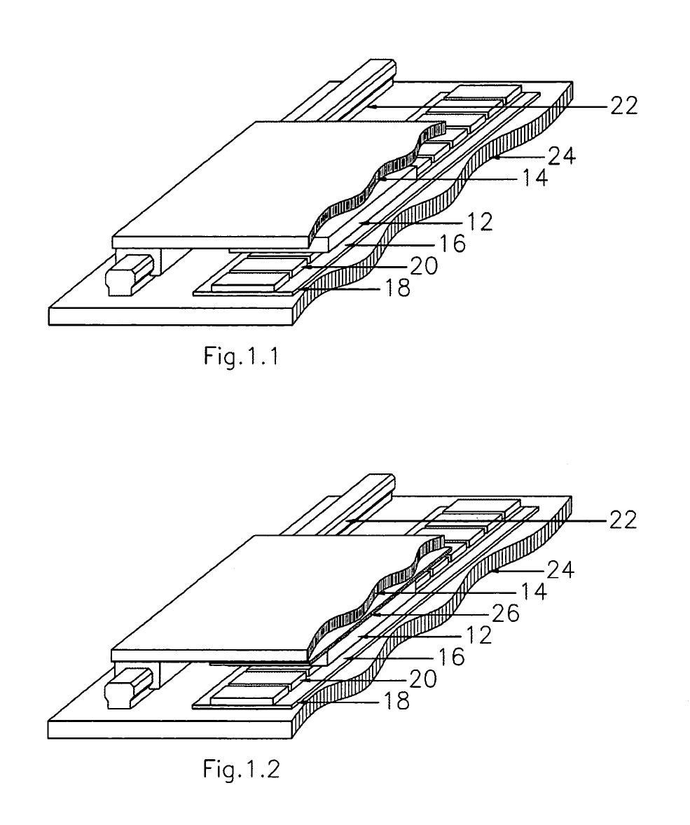

Linear actuator with linear flat electric machine is shown on FIG. 1.1. Actuator consists of forcer 12, mounted to the table top 14 (usually made of conductive material, for example, aluminum), and magnet track 16. Magnet track 16 consists of magnetic plate 18 and magnets 20. Table top is mounted to linear bearings 22. Linear bearings and magnetic plate are installed on the actuator base 24. During machine moving the Eddy current losses will occur in the table top.

The construction of the invented linear electric actuator with linear flat electric machine includes forcer 12 mounted to the table top 14 with Eddy current reducer 26 (FIG. 1.2). Reducer prevents Eddy current losses in the table top.

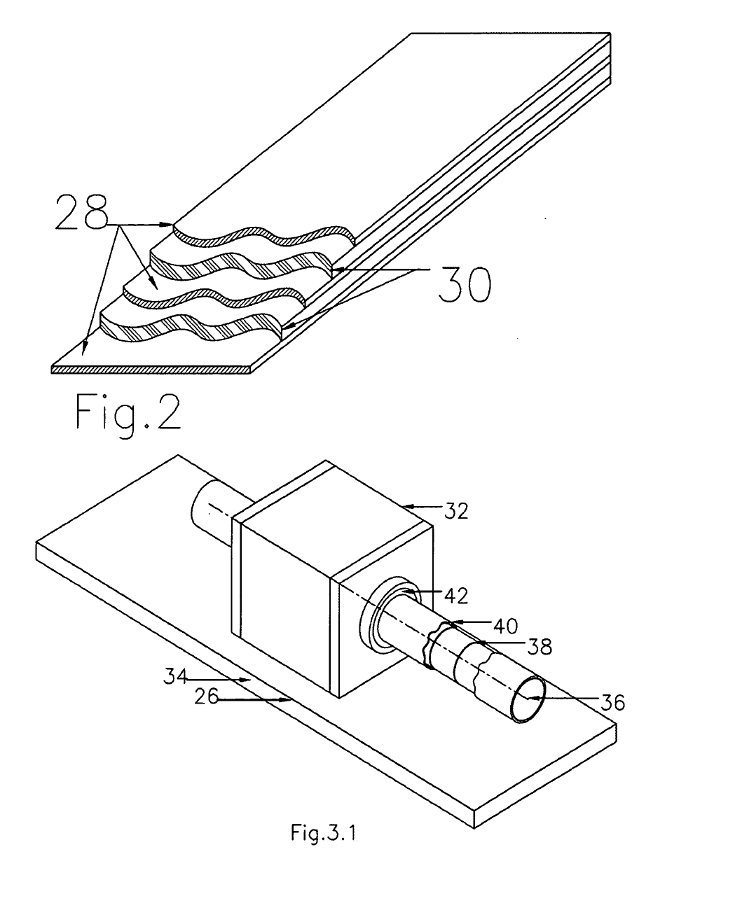

The Eddy current reducer for linear actuator with linear flat electric machine is shown on FIG. 2. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 28 are divided one from another by non-magnetic spacers 30. The thickness of pieces is 0.010-1.0 mm each (or other depending on applications). The exact dimensions and quantity of pieces depend on electromechanical design and are subject for optimization.

The invented design of linear actuator with linear flat electric machine not only reduces the module of magnetic field in conductive part but it also greatly reduces the normal component of magnetic field which creates Eddy currents (thereby the tangential component may increase but it do not create Eddy currents). Due to this feature, the very thin and magnetically saturated eddy current reducer has insignificant magnetic attraction and cogging. The Eddy current reducer finally reduces eddy current losses in table top 14.

Linear Actuator with Linear Tube Electric Machine.

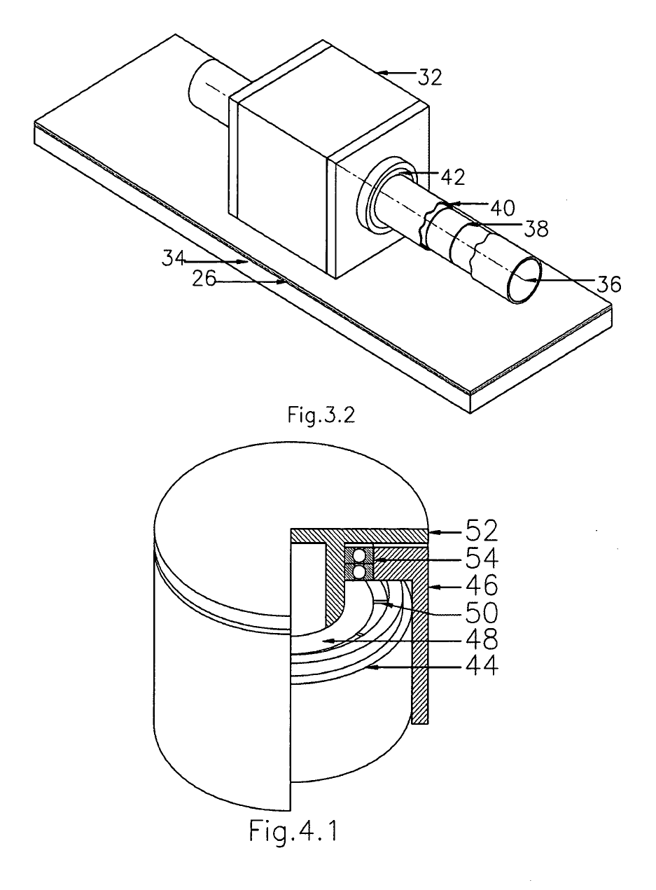

Linear actuator with linear tube electric machine is shown on FIG. 3.1. Actuator consists of forcer 32, mounted to the actuator base 34 (usually made of conductive material, for example, aluminum), and magnet track 36. Magnet track 36 consists of magnets 38 placed inside tube 40. Magnet track is supported by linear bearings 42. During machine moving the Eddy current losses will occur in the actuator base.

The construction of the invented linear electric actuator with linear tube electric machine includes forcer 32 mounted to the actuator base 34 with Eddy current reducer 26 (FIG. 3.2). Reducer prevents Eddy current losses in the actuator base.

The Eddy current reducer for linear actuator with linear tube electric machine is shown on FIG. 2. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 28 are divided one from another by non-magnetic spacers 30. The thickness of pieces is 0.010-1.0 mm each (or other depending on applications). The exact dimensions and quantity of pieces depend on electromechanical design and are subject for optimization.

The invented design of linear actuator with linear tube electric machine not only reduces the module of magnetic field in conductive part but it also greatly reduces the normal component of magnetic field which creates Eddy currents (thereby the tangential component may increase but it do not create Eddy currents). The Eddy current reducer finally reduces eddy current losses in actuator base 34.

Rotary Actuator with Rotary Radial (Magnets Inside) Ironless Electric Machine.

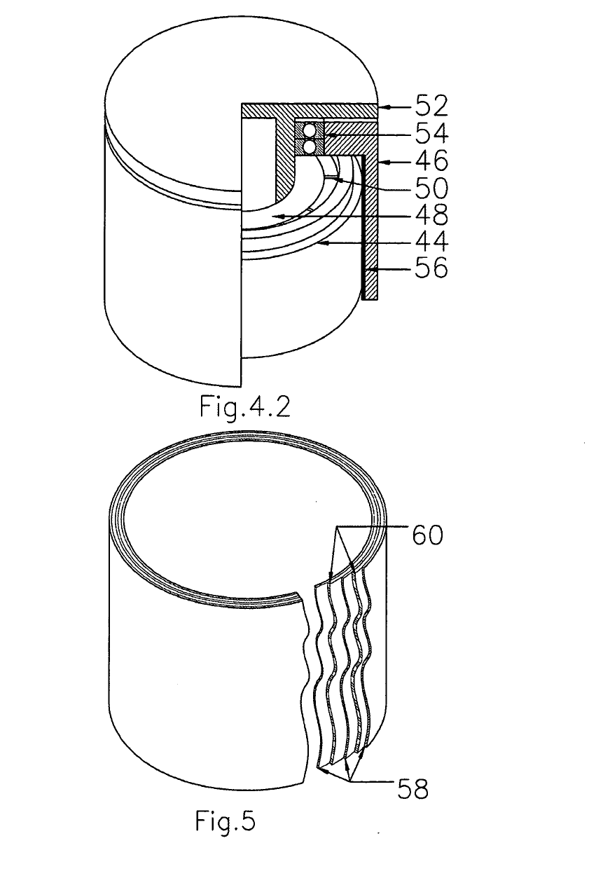

Rotary actuator with rotary radial (magnets inside) ironless electric machine is shown on FIG. 4.1. Actuator consists of ironless stator 44, mounted to the actuator housing 46 (usually made of conductive material, for example, aluminum), and rotor 48 with magnets 50. Rotor is mounted to table top 52 that is supported by bearings 54. During machine rotating the Eddy current losses will occur in the actuator housing.

The construction of the invented rotary electric actuator with rotary radial (magnets inside) ironless electric machine includes ironless stator 44 mounted to the actuator housing 46 with Eddy current reducer 56 (FIG. 4.2). Reducer prevents Eddy current losses in the actuator housing.

The Eddy current reducer for rotary actuator with rotary radial (magnets inside) ironless electric machine is shown on FIG. 5. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 58 are divided one from another by non-magnetic spacers 60. The thickness of pieces is 0.010-.0 mm each (or other depending on applications). The exact dimensions and quantity of pieces depend on electromechanical design and are subject for optimization.

The invented design of rotary actuator with rotary radial (magnets inside) ironless electric machine not only reduces the module of magnetic field in conductive part but it also greatly reduces the normal component of magnetic field which creates Eddy currents (thereby the tangential component may increase but it do not create Eddy currents). The Eddy current reducer finally reduces eddy current losses in actuator housing 46.

Rotary Actuator with Rotary Radial (Magnets Outside) Ironless Electric Machine.

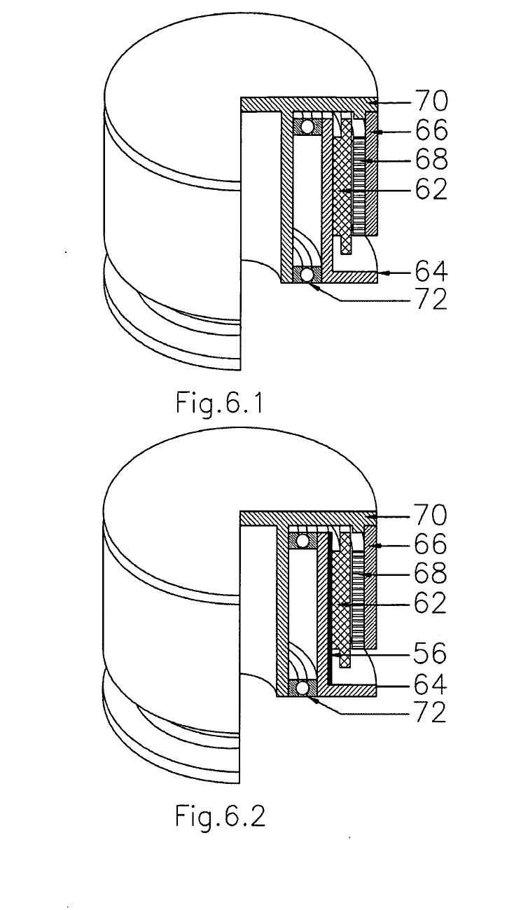

Rotary actuator with rotary radial (magnets outside) ironless electric machine is shown on FIG. 6.1. Actuator consists of ironless stator 62, mounted to the actuator housing 64 (usually made of conductive material, for example, aluminum), and rotor 66 with magnets 68. Rotor is mounted to table top 70 that is supported by bearings 72. During machine rotating the Eddy current losses will occur in the actuator housing.

The construction of the invented rotary electric actuator with rotary radial (magnets outside) ironless electric machine includes ironless stator 62 mounted to the actuator housing 64 with Eddy current reducer 56 (FIG. 6.2). Reducer prevents Eddy current losses in the actuator housing.

The Eddy current reducer losses for rotary actuator with rotary radial (magnets outside) ironless electric machine is shown on FIG. 5. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 58 are divided one from another by non-magnetic spacers 60. The thickness of pieces is 0.010-1.0 mm each (or other depending on applications). The exact dimensions and quantity of pieces depend on electromechanical design and are subject for optimization.

The invented design of rotary actuator with rotary radial (magnets outside) ironless electric machine not only reduces the module of magnetic field in conductive part but it also greatly reduces the normal component of magnetic field which creates Eddy currents (thereby the tangential component may increase but it do not create Eddy currents). The Eddy current reducer finally reduces eddy current losses in actuator housing 64.

Rotary Actuator with Rotary Axial Ironless Electric Machine.

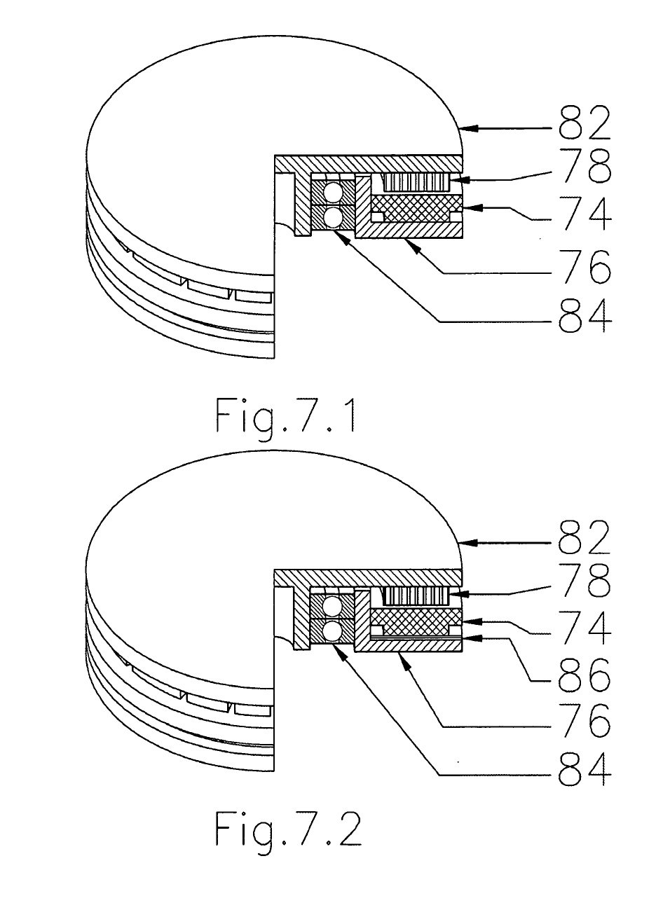

Rotary actuator with rotary axial ironless electric machine is shown on FIG. 7.1. Actuator consists of ironless stator 74, mounted to the actuator housing 76 (usually made of conductive material, for example, aluminum), and rotor 78. Rotor is mounted to table top 82 that is supported by bearings 84. During machine rotating the Eddy current losses will occur in the actuator housing.

The construction of the invented rotary electric actuator with rotary axial ironless electric machine includes ironless stator 74 mounted to the actuator housing 76 with Eddy current reducer 86 (FIG. 7.2). Reducer prevents Eddy current losses in the actuator housing.

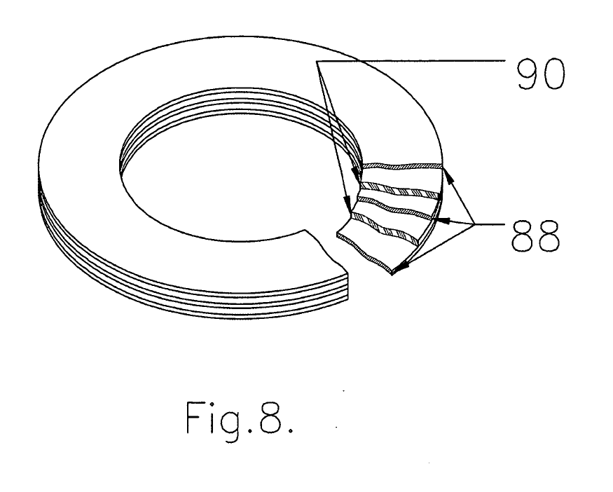

The Eddy current reducer for rotary actuator with rotary axial electric machine is shown on FIG. 8. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 88 are divided one from another by non-magnetic spacers 90. The thickness of pieces is 0.010-1.0 mm each (or other depending on applications). The exact dimensions and quantity of pieces depend on electromechanical design and are subject for optimization.

The invented design of rotary actuator with rotary axial ironless electric machine not only reduces the module of magnetic field in conductive part but it also greatly reduces the normal component of magnetic field which creates Eddy currents (thereby the tangential component may increase but it do not create Eddy currents). The Eddy current reducer finally reduces eddy current losses in actuator base 76.

1. To prevent Eddy current losses in electric actuator, the new electric actuator with incorporated Eddy current reducer is invented. The Eddy current reducer is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces are divided one from another by non-magnetic spacers. The reducer is installed inside actuator close to moving conductive part at the side toward the stationary magnets, or close to stationary conductive part at the side toward the moving magnets (or between conductive part, where eddy current losses are occurred and magnets).

2. To prevent Eddy current losses in linear actuator with linear flat electric machine, the new electric actuator with incorporated Eddy current reducer is invented. The Eddy current reducer is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces are divided one from another by non-magnetic spacers (FIG. 2). The reducer is installed inside actuator close to moving conductive part at the side toward the stationary magnets, or close to stationary conductive part at the side toward the moving magnets (or between conductive part, where eddy current losses are occurred and magnets—FIG. 1.2).

3. To prevent Eddy current losses in linear actuator with linear tube electric machine, the new electric actuator with incorporated Eddy current reducer is invented. The Eddy current reducer is made of one or more assembled or solid pieces of oriented or non-oriented ferromagnetic material or compound (any shape, form, configuration or structure, solid or from parts, examples—sheets with or without holes, net, arid, bars, strips, etc.). Ferromagnetic pieces are divided one from another by non-magnetic spacers (FIG. 2). The reducer is installed inside actuator close to moving conductive part at the side toward the stationary magnets, or close to stationary conductive part at the side toward the moving magnets (or between conductive part, where eddy current losses are occurred and magnets—FIG. 3.2).

4. To prevent Eddy current losses in rotary actuator with rotary radial (magnets inside) ironless electric machine, the new electric actuator with incorporated Eddy current reducer is invented. The Eddy current reducer is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces are divided one from another by non-magnetic spacers (FIG. 5). The reducer is installed inside actuator close to moving conductive part at the side toward the stationary magnets, or close to stationary conductive part at the side toward the moving magnets (or between conductive part, where eddy current losses are occurred and magnets—FIG. 4.2).

5. To prevent Eddy current losses in rotary actuator with rotary radial (magnets outside) ironless electric machine, the new electric actuator with incorporated Eddy current reducer is invented. The Eddy current reducer is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces are divided one from another by non-magnetic spacers (FIG. 5). The reducer is installed inside actuator close to moving conductive part at the side toward the stationary magnets, or close to stationary conductive part at the side toward the moving magnets (or between conductive part, where eddy current losses are occurred and magnets—FIG. 6.2).

6. To prevent Eddy current losses in rotary actuator with rotary axial ironless electric machine, the new electric actuator with incorporated Eddy current reducer is invented. The Eddy current reducer is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces are divided one from another by non-maanetic spacers (FIG. 8). The reducer is installed inside actuator close to moving conductive part at the side toward the stationary magnets, or close to stationary conductive part at the side toward the moving magnets (or between conductive part, where eddy current losses are occurred and magnets—FIG. 7.2).

1. An electrical actuator including:
conductive material of a character in which magnetic fields induce eddy currents;
magnets adapted to produce said magnetic fields; and
an Eddy current reducer interposed between said conductive material and said magnets and comprising a piece comprised of ferromagnetic material.

2. An electrical actuator according to claim 1, wherein said ferromagnetic material is oriented.

3. An electrical actuator according to claim 1. wherein said piece of ferromagnetic material is 0.01 to 1.0 mm thick.

4. An electrical actuator according to claim 1, wherein said reducer is in the form of a sandwich comprising a plurality of pieces comprised of ferromagnetic material and alternating with non-magnetic spacers.

5. A flat electrical actuator including:
conductive carrier;
forcer with coils placed on said carrier;
flat magnet track with magnets placed on said magnet track and mounted so that magnetic interaction with said coils is possible; notably said forcer and said magnet track are mounted so that mutual displacement from one another is possible; and
an Eddy current reducer interposed between said conductive carrier and said magnets and comprising a piece comprised of ferromagnetic material.

6. An electrical actuator according to claim 5, wherein said ferromagnetic material is oriented.

7. An electrical actuator according to claim 5. wherein said piece of ferromagnetic material is 0.01 to 1.0 mm thick.

8. An electrical actuator according to claim 5, wherein said reducer is in the form of a sandwich comprising a plurality of pieces comprised of ferromagnetic material and alternating with non-magnetic spacers.

9. A tube electrical actuator including:
conductive carrier;
forcer with coils placed on said carrier;
tube magnet track with magnets placed on said magnet track and mounted so that magnetic interaction with said coils is possible; notably said forcer and said magnet track are mounted so that mutual displacement from one another is possible; and
an Eddy current reducer interposed between said conductive carrier and said magnets and comprising a piece comprised of ferromagnetic material.

10. An electrical actuator according to claim 9, wherein said ferromagnetic material is oriented.

11. An electrical actuator according to claim 9, wherein said piece of ferromagnetic material is 0.01 to 1.0 mm thick.

12. An electrical actuator according to claim 9, wherein said reducer is in the form of a sandwich comprising a plurality of pieces comprised of ferromagnetic material and alternating with non-magnetic spacers.

13. A rotary electrical actuator including:
conductive carrier;
stator with coils placed inside of hole in said carrier;
rotor wrapped by said carrier and by said stator mounted so that mutual rotary movement relative to said carrier and said stator is possible;
magnets placed on said rotor and mounted so that magnetic interaction with said coils is possible; and
an Eddy current reducer interposed between said conductive carrier and said magnets and comprising a piece comprised of ferromagnetic material.

14. An electrical actuator according to claim 13, wherein said ferromagnetic material is oriented.

15. An electrical actuator according to claim 13, wherein said piece of ferromagnetic material is 0.01 to 1.0 mm thick.

16. An electrical actuator according to claim 13, wherein said reducer is in the form of a sandwich comprising a plurality of pieces comprised of ferromagnetic material and alternating with non-magnetic spacers.

17. A rotary electrical actuator including:
stator with coils;
conductive carrier placed inside of hole in said stator;
rotor wrapping said carrier and said stator mounted so that mutual rotary movement relative to said carrier and said stator is possible;
magnets placed on said rotor and mounted so that magnetic interaction with said coils is possible; and
an Eddy current reducer interposed between said conductive carrier and said magnets and comprising a piece comprised of ferromagnetic material.

18. An electrical actuator according to claim 17, wherein said ferromagnetic material is oriented.

19. An electrical actuator according to claim 17, wherein said piece of ferromagnetic material is 0.01 to 1.0 mm thick.

20. An electrical actuator according to claim 17, wherein said reducer is in the form of a sandwich comprising a plurality of pieces comprised of ferromagnetic material and alternating with non-magnetic spacers.

21. A flat rotary electrical actuator including:
conductive carrier;
flat stator with coils placed on said carrier;
flat rotor with magnets placed on said rotor and mounted so that magnetic interaction with said coils is possible; notably said stator and said rotor are mounted so that mutual movement from one another is possible; and
an Eddy current reducer interposed between said conductive carrier and said magnets and comprising a piece comprised of ferromagnetic material.

22. An electrical actuator according to claim 21, wherein said ferromagnetic material is oriented.

23. An electrical actuator according to claim 21, wherein said piece of ferromagnetic material is 0.01 to 1.0 mm thick.

24. An electrical actuator according to claim 21, wherein said reducer is in the form of a sandwich comprising a plurality of pieces comprised of ferromagnetic material and alternating with non-magnetic spacers.
